(19) United States
(12) Patent Application Publication
(10) Pub. No.: US 2026/0233741 A1
(43) Pub. Date: Aug. 13, 2026

(54) INTELLIGENT REGENERATIVE BRAKING METHOD AND APPARATUS

(71) Applicants: HYUNDAI MOTOR COMPANY, Seoul (KR); KIA CORPORATION, Seoul (KR); SOOKMYUNG WOMEN'S UNIVERSITY INDUSTRY-ACADEMIC COOPERATION FOUNDATION, Seoul (KR)

(72) Inventors: Gyu Bin Sim, Hwaseong-si (KR); Jin Wook Kim, Hwaseong-si (KR); Seung Yeon Oak, Seoul (KR); Soo Young Kim, Gwangmyeong-si (KR); Dae Kyeong Lee, Seoul (KR)

(73) Assignees: HYUNDAI MOTOR COMPANY, Seoul (KR); KIA CORPORATION, Seoul (KR); SOOKMYUNG WOMEN'S UNIVERSITY INDUSTRY-ACADEMIC COOPERATION FOUNDATION, Seoul (KR)

(21) Appl. No.: 19/247,756

(22) Filed: Jun. 24, 2025

(30) Foreign Application Priority Data
Feb. 10, 2025 (KR) 10-2025-0016798

(51) Int. Cl. B60W 30/18; B60W 30/16; B60W 40/09; B60W 50/00

(52) U.S. Cl. CPC B60W 30/18127; B60W 30/16; B60W 30/18072; B60W 40/09; B60W 50/00; B60W 2050/0056; B60W 2520/10; B60W 2540/10; B60W 2540/12; B60W 2554/802

(57) ABSTRACT

An intelligent regenerative braking method according to an embodiment of the present disclosure includes: detecting a pedal intervention of the driver and learning, based on the pedal intervention of the driver, a tendency of the driver in acceleration and deceleration based on whether deceleration by an intelligent regenerative braking mode is performed or not when an acceleration pedal is released during driving and there is a preceding vehicle; and controlling regenerative braking in a coasting situation based on the tendency of the driver.

### CROSS REFERENCE TO RELATED APPLICATION

The present application claims priority to Korean Patent Application No. 10-2025-0016798, filed Feb. 10, 2025, the entire contents of which are incorporated herein by reference.

### TECHNICAL FIELD

The present disclosure relates to an eco-friendly vehicle. More specifically, the present disclosure relates to a method and apparatus for providing intelligent regenerative braking.

### BACKGROUND

Generally, a Hybrid Electronic Vehicle (HEV) refers to a vehicle that is driven by using a driving force provided by an engine and a motor, and an Electronic Vehicle (EV) refers to a vehicle that is driven by using a driving force provided by a motor.

Such an HEV or an EV is configured to be driven by receiving a driving force provided by a motor when the HEV or the EV starts to be driven or is driven at a speed equal to or less than a predetermined speed. In a situation in which the vehicle is driven, when a driver does not press both an accelerator and a brake, coasting in which the vehicle is driven by inertia is performed, and a regenerative braking function is operated during coasting.

Recently, an intelligent regenerative braking system in which a vehicle automatically adjusts speed and braking according to a road situation during coasting has been developed.

However, in a conventional intelligent regenerative braking system, a driver's tendency is not reflected when a deceleration profile is generated. Therefore, even when the driver does not like a deceleration pattern of the vehicle and the driver intervenes in acceleration and deceleration, such acceleration and deceleration pattern is not reflected in a subsequent regenerative braking.

The statements in this Background section merely provide background information related to the present disclosure and may not constitute prior art.

### SUMMARY

In view of the foregoing, there is a need for a technology capable of learning a pedal intervention tendency of a driver while the driver intervenes in acceleration and deceleration during performing a regenerative braking operation and then reflecting the pedal intervention tendency of the driver in driving.

Accordingly, the present disclosure has been made to solve the above problems. An aspect of the present disclosure is to provide a technology for learning a pedal intervention tendency of a driver while the driver intervenes in acceleration and deceleration during performing a regenerative braking operation and for reflecting the pedal intervention tendency of the driver in driving.

Another aspect of the present disclosure is to provide a technology for providing an intelligent regenerative braking in which a pedal intervention tendency of a driver is reflected, thereby being capable of minimizing a driver's intervention in acceleration and deceleration during performing a regenerative braking function.

Aspects of the present disclosure are not limited to the above-mentioned aspects, and other aspects not mentioned herein should be clearly understood by those having ordinary skill in the art from the following description.

According to an aspect of the present disclosure, a regenerative braking method includes: when or based on that an acceleration pedal is released during driving and there is a preceding vehicle, detecting or determining a pedal intervention of a driver (also referred to as “a driver's pedal intervention) and learning, based on the pedal intervention of the driver, a tendency of the driver (also referred to as “a driver's tendency”) in acceleration and deceleration, according to or based on whether deceleration by an intelligent regenerative braking mode is performed or not; and controlling regenerative braking in a coasting situation based on the learned tendency of the driver in acceleration and deceleration.

Learning the tendency of the driver may include: when or based on that the deceleration by the intelligent regenerative braking mode is performed, determining the tendency of the driver in acceleration and deceleration based on whether the acceleration pedal or a brake pedal is operated or not; and when or based on that the deceleration by the intelligent regenerative braking mode is not performed, determining the tendency of the driver in acceleration and deceleration based on whether the brake pedal is operated or not.

Learning the tendency of the driver in acceleration and deceleration may include updating a learning parameter for determining a target distance to the preceding vehicle based on the learned tendency of the driver in acceleration and deceleration.

Controlling the regenerative braking may include: determining a target distance to the preceding vehicle based on the learned tendency of the driver in acceleration and deceleration; and controlling the regenerative braking based on the target distance.

Controlling the regenerative braking based on the target distance may include: determining a target acceleration based on the target distance; determining a regenerative torque for following or based on the target acceleration; and controlling a driving motor based on the regenerative torque.

The learning parameter may include: a time interval between the vehicle and the preceding vehicle; and a proportional constant of a square of a relative speed between the vehicle and the preceding vehicle.

The learning parameter may be updated based on a parametric error between a learning reference value and the target distance which is initially set or which is determined by a previous learning.

The learning parameter may be updated by an Extended Kalman Filter based on the parametric error.

The target distance to the preceding vehicle may be determined based on the learning parameter, a minimum maintaining distance to the preceding vehicle, a speed of the vehicle, and a relative speed between the vehicle and the preceding vehicle.

The preceding vehicle may be in front of the vehicle.

According to an aspect of the present disclosure, a regenerative braking apparatus includes: a driving motor; and a control unit. The control unit is configured to, when or based on that an acceleration pedal is released during driving and there is a preceding vehicle, detect or determine a pedal intervention of the driver and learn, based on the pedal intervention of the driver, a tendency of the driver in acceleration and deceleration according to or based on whether deceleration by an intelligent regenerative braking mode is performed or not. The control unit is further configured to control regenerative braking in a coasting situation based on the learned tendency of the driver in acceleration and deceleration.

The control unit may be further configured to: when or based on that the deceleration by the intelligent regenerative braking mode is performed, learn the tendency of the driver in acceleration and deceleration based on whether the acceleration pedal and a brake pedal are operated or not; and when or based on that the deceleration by the intelligent regenerative braking mode is not performed, learn the tendency of the driver in acceleration and deceleration based on whether the brake pedal is operated or not.

The control unit may be further configured to update a learning parameter for determining a target distance to the preceding vehicle based on the learned tendency of the driver in acceleration and deceleration.

The control unit may be further configured to determine a target distance to the preceding vehicle based on the learned tendency of the driver in acceleration and deceleration, and control the driving motor based on the target distance.

The control unit may be further configured to determine a target acceleration based on the target distance, determine a regenerative torque for following or based on the target acceleration, and control the driving motor based on the regenerative torque.

The learning parameter may include a time interval between the vehicle and the preceding vehicle; and a proportional constant of a square of a relative speed between the vehicle and the preceding vehicle.

The learning parameter may be updated based on a parametric error between a learning reference value and the target distance which is initially set or which is determined by a previous learning.

The learning parameter may be updated by an Extended Kalman Filter based on the parametric error.

The target distance to the preceding vehicle may be determined based on the learning parameter, a minimum maintaining distance to the preceding vehicle, a speed of the vehicle, and a relative speed between the vehicle and the preceding vehicle.

The preceding vehicle may be in front of the vehicle.

### BRIEF DESCRIPTION OF THE DRAWINGS

The above and other objectives, features, and other advantages of the present disclosure should be more clearly understood from the following detailed description when taken in conjunction with the accompanying drawings, in which:

FIG. 1 is a schematic view illustrating a configuration of an intelligent regenerative braking apparatus according to an embodiment of the present disclosure;

FIG. 2 is a control diagram illustrating a learning algorithm of a target distance determination unit in FIG. 1;

FIG. 3 is an example of a graph showing a relationship between a relative speed and a target distance according to an embodiment of the present disclosure;

FIG. 4 is a flowchart illustrating an intelligent regenerative braking method according to an embodiment of the present disclosure; and

FIG. 5 is an example of a graph showing a driver's intervention in acceleration and deceleration according to an embodiment of the present disclosure.

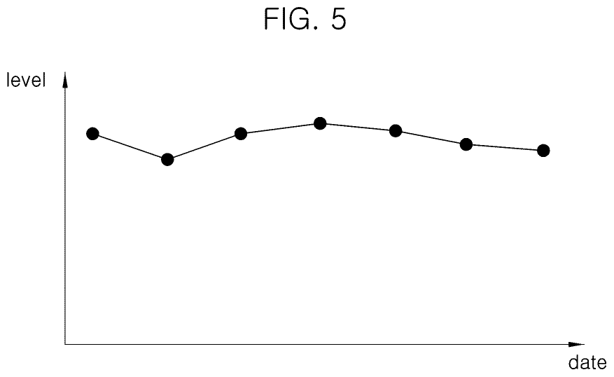

The drawings described herein are for illustration purposes only and are not intended to limit the scope of the present disclosure in any way.

### DETAILED DESCRIPTION

In the following description, the structural or functional description specified to embodiments according to the concept of the present disclosure is intended to describe embodiments, so it should be understood that the present disclosure may be variously embodied, without being limited to embodiments.

Embodiments described herein may be changed in various ways and various shapes, so specific embodiments are shown in the drawings and are described in detail in this specification. However, it should be understood that embodiments according to the concept of the present disclosure are not limited to embodiments which are described hereinbelow with reference to the accompanying drawings, but all of modifications, equivalents, and substitutions are included in the scope and spirit of the present disclosure.

Unless otherwise defined, all terms used herein, including technical or scientific terms, have the same meaning as commonly understood by one of ordinary skill in the art to which the present disclosure belongs. Terms such as those defined in a commonly used dictionary should be interpreted as having a meaning consistent with the meaning of the related technology, and should not be interpreted as an ideal or excessively formal meaning unless explicitly defined in the present specification.

Hereinafter, embodiments disclosed in the present specification are described in detail with reference to the accompanying drawings. In the present specification, the same or similar components are denoted by the same or similar reference numerals, and a repeated description thereof has been omitted.

In the description of the following embodiments, the term “preset” means that the numerical value of a parameter is determined in advance when the parameter is used in a process or algorithm. According to an embodiment, the numerical value of a parameter may be set when a process or algorithm starts or may be set during a period in which the process or algorithm is executed.

In the following description, the expressions “module” and “part” contained in terms of constituent components to be described are selected or used together in consideration only of the convenience of writing the following specification, and the expressions “module” and “part” do not necessarily have different meanings or roles.

Detailed description of known technologies has been omitted if it is determined that the detailed description of the known technologies obscures embodiments of the present specification. In addition, the accompanying drawings are merely intended to easily describe embodiments of the present specification, but the spirit and technical scope of the present specification is not limited by the accompanying drawings. It should be understood that the present specification is not limited to specific disclosed embodiments, but includes all modifications, equivalents and substitutes included within the spirit and technical scope of the present disclosure.

Terms including ordinals such as “first” or “second” used herein may be used to describe various components, but the components are not limited by the terms. The terms are used only for the purpose of distinguishing one constituent element from another constituent element.

When a component is described as being “connected”, “coupled”, or “linked” to another component, that component may be directly connected, coupled, or linked to that other component. However, it should be understood that yet another component between each of the components may be present. In contrast, it should be understood that when a component is referred to as being “directly coupled” or “directly connected” to another component, there are no intervening components present.

Singular expressions include plural expressions unless the context clearly indicates otherwise.

It is to be understood that terms such as “comprising”, “including”, “having”, and so on are intended to indicate the existence of the features, numbers, steps, actions, elements, components, or combinations thereof disclosed in the specification, and are not intended to preclude the possibility that one or more other features, numbers, steps, actions, elements, components, or combinations thereof may exist or may be added.

In addition, “unit” or “control unit” included in the names of the motor control unit (MCU) and the hybrid control unit (HCU) generally refer to a controller that controls a specific function of the vehicle and do not mean a generic function unit.

In addition, “controller” may include a communication device configured to communicate with another controller or a sensor in order to control a function assigned thereto, a memory configured to store an operating system, logic commands, and input and output information, and at least one processor configured to perform determination, calculation, and decision necessary to control the assigned function.

When a component, unit, controller, device, element, apparatus, or the like of the present disclosure is described as having a purpose or performing an operation, function, or the like, the component, unit, controller, device, element, apparatus, or the like should be considered herein as being “configured to” meet that purpose or to perform that operation or function. Each component, unit, controller, device, element, apparatus, and the like may separately embody or be included with a processor and a memory, such as a non-transitory computer readable media, as part of the apparatus.

The term “unit” or “module” used in this specification signifies one unit that processes at least one function or operation, and may be realized by hardware, software, or a combination thereof. The operations of the method or the functions described in connection with the forms disclosed herein may be embodied directly in a hardware or a software module executed by a processor, or in a combination thereof.

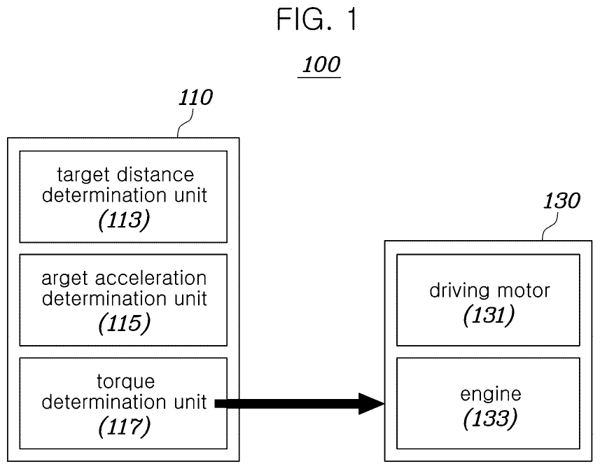

FIG. 1 is a schematic view illustrating a configuration of an intelligent regenerative braking apparatus according to an embodiment of the present disclosure.

Referring to FIG. 1, an intelligent regenerative braking apparatus 100 according to the present embodiment includes a control unit 110 and a powertrain 130.

The control unit 110 includes a target distance determination unit 113, a target acceleration determination unit 115, and a torque determination unit 117.

The target distance determination unit 113 is configured to determine a target distance to a preceding vehicle in front of a vehicle by considering a speed of the vehicle, a relative speed to the preceding vehicle, and so on.

In a situation in which the vehicle is in an intelligent regenerative braking mode, when a driver's accelerator pedal or brake pedal intervention is detected, the target distance determination unit 113 updates a parameter for determining the target distance by reflecting a driver's intention in acceleration and deceleration.

The target distance determination unit 113 determines the target distance to the preceding vehicle based on an updated parameter during a next coasting.

The target acceleration determination unit 115 is configured to determine a target acceleration of the vehicle for reaching the target distance to the preceding vehicle determined in the target distance determination unit 113.

The target acceleration determination unit 115 may determine the target acceleration of the vehicle by using a Proportional-Integral-Derivative (PID) control algorithm.

The PID control algorithm is a feedback control algorithm used for improving a control performance of a system.

The torque determination unit 117 is configured to determine a torque required to follow the target acceleration determined in the target acceleration determination unit 115, and is configured to control the powertrain 130 based on the determined torque.

The powertrain 130 is configured to perform an operation for maintaining the target distance to the preceding vehicle in front of the vehicle by being controlled by the control unit 110.

The powertrain 130 may include a driving motor 131. Furthermore, in a hybrid vehicle, the powertrain 130 may further include an engine 133.

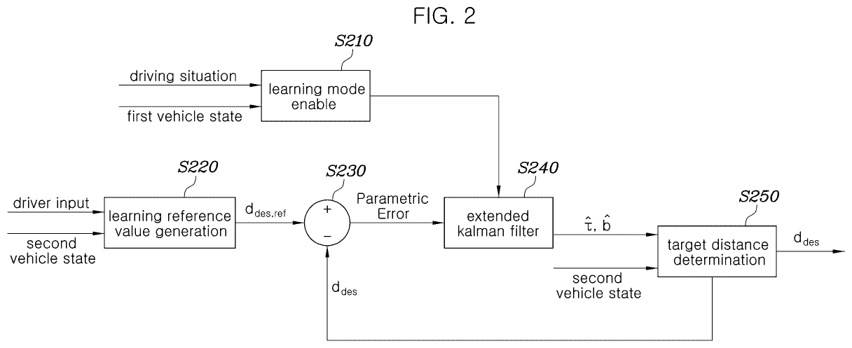

The intelligent regenerative braking mode according to an embodiment may be performed by a regenerative braking torque control of the driving motor 131. FIG. 2 is a control diagram illustrating a learning algorithm of the target distance determination unit 113 in FIG. 1.

Referring to FIG. 2, the target distance determination unit 113 activates an intelligent regenerative braking learning mode based on a driving situation and a first vehicle state (S210).

The driving situation may include, for example, whether another vehicle preceding in front of the vehicle exists.

The first vehicle state may include, for example, whether an operation of the accelerator pedal is released, and may include whether a deceleration by the intelligent regenerative braking mode of the vehicle is performed.

In addition, the target distance determination unit 113 generates a learning reference value based on a driver's input and a second vehicle state (S220).

The driver's input may include an accelerator pedal input and a brake pedal input.

The second vehicle state may include a current speed of the vehicle and a relative speed to the preceding vehicle.

The generated learning reference value may be a relative distance to the preceding vehicle when the driver intervenes.

In addition, the target distance determination unit 113 generates a parametric error between the learning reference value generated in the process S220 and the target distance to the preceding vehicle (S230), and generates a learning parameter by an Extended Kalman Filter (EKF) based on the generated parametric error (S240).

In the process S230, the target distance to the preceding vehicle may be an initially set value or a result value generated by a previous learning.

The generated learning parameters may include a time interval (\hat{τ}) and a braking index (\hat{b}).

The time interval represents a gap between the preceding vehicle and the current vehicle in units of time. The time interval between the current vehicle and the preceding vehicle depends on how long it takes for the present vehicle to reach the position of the preceding vehicle at its current spend. For example, if the current vehicle takes 2 seconds to reach the preceding vehicle's current position, then the time interval is two seconds.

The braking index (\hat{b}) represents a constant that is proportional to the square of the relative speed between the preceding vehicle and the current vehicle for calculating the target distance to the preceding vehicle. Furthermore, as the braking index value increases, the target distance increases.

In addition, the target distance determination unit 113 determines the target distance to the preceding vehicle based on the learning parameter and the second vehicle state (S250).

The second vehicle state may include a current speed of the vehicle and a relative speed to the preceding vehicle.

The target distance may be calculated by Equation 1 below.

$${d}_{des} = {d}_{s} + \hat{τ} {v}_{ego} + \hat{b} Δ {v}^{2} \qquad [ Equation 1 ]$$

In Equation 1, d_{des} represents a target distance to the preceding vehicle, dₛ represents a minimum maintaining distance to the preceding vehicle, \hat{τ} represents a time interval between the preceding vehicle and the current vehicle, v_{ego} represents a current speed of the vehicle, \hat{b} represents a proportional constant for the square of a relative speed between the preceding vehicle and the current vehicle, and Δv represents the relative speed between the preceding vehicle and the current vehicle.

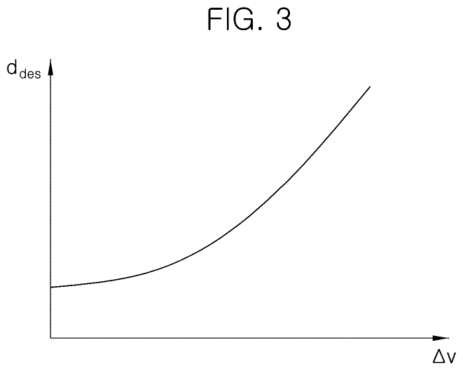

For example, when it is assumed that the remaining parameters of Equation 1 have fixed values, the target distance d_{des} to the preceding vehicle and the relative speed Av between the preceding vehicle and the current vehicle may have the relationship as shown in FIG. 3.

Referring to FIG. 3, the target distance d_{des} to the preceding vehicle increases in proportion to the square as the relative speed Av increases.

Referring to FIG. 2 again, the target distance to the preceding vehicle determined in the process S250 may be used as an input value for generating the parametric error between the learning reference value and the target distance to the preceding vehicle in the process S230.

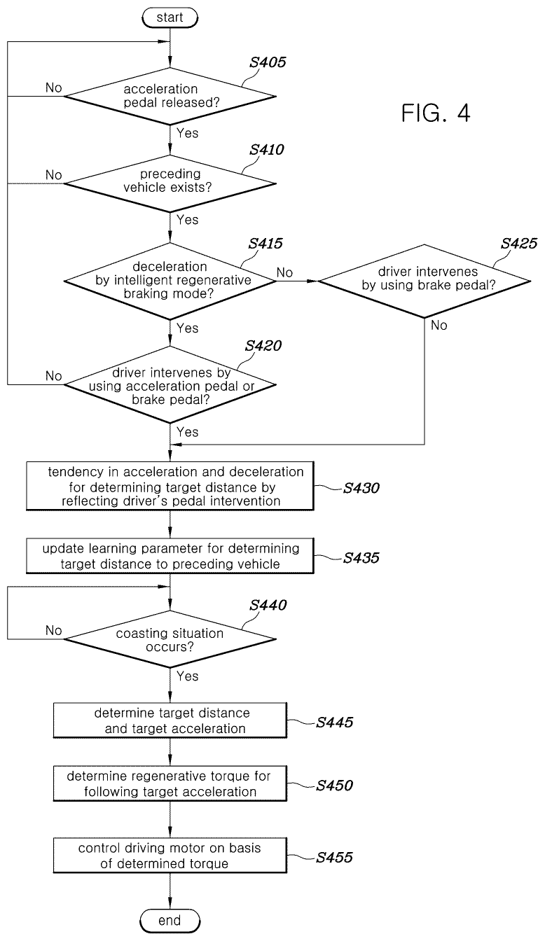

FIG. 4 is a flowchart illustrating an intelligent regenerative braking method according to an embodiment of the present disclosure.

An intelligent regenerative braking method according to the present embodiment may be performed by the control unit 110 in FIG. 1.

Referring to FIG. 4, the control unit 110 determines whether the accelerator pedal of the vehicle is released while driving (S405). Furthermore, when the accelerator pedal operation is released (Yes in S405), the control unit 110 determines whether a preceding vehicle exists in front of the vehicle (S410). Furthermore, when there is the preceding vehicle in front of the vehicle (Yes in S410), the control unit 110 determines whether a deceleration by the intelligent regenerative braking mode is performed (S415).

As a result of the determination in the process S415, when the deceleration by the intelligent regenerative braking mode is performed (Yes in S415), the control unit 110 may determine whether the driver intervenes by using the accelerator pedal or the brake pedal (S420).

The statement that the deceleration by the intelligent regenerative braking mode is performed may mean that a regenerative torque larger than a regenerative torque during basic coasting is output from the driving motor as the distance to the preceding vehicle decreases.

As a result of the determination in the process S415, when the deceleration by the intelligent regenerative braking mode is not performed (No in S415), the control unit 110 determines whether the driver intervenes by using the brake pedal, i.e., whether an intervention by the deceleration pedal exists (S425). Furthermore, when the driver intervenes by using the brake pedal (Yes in S425), the control unit 110 reflects the driver's brake pedal intervention and learns a driver's pattern in acceleration and deceleration (S430), updates the learning parameter for determining the target distance to the preceding vehicle (S435), and determines whether a coasting situation occurs during a next driving (S440). In other words, since the driver has already released the accelerator pedal operation, the driver has no intention in acceleration. Furthermore, since an additional deceleration by the intelligent regenerative braking mode is not performed, learning according to whether or not the accelerator pedal is operated is unnecessary, and learning according to whether or not the brake pedal is operated is performed only.

If the driver operates the brake pedal, it can be interpreted that the driver desires a longer target distance compared to the current parameter, so that learning proceeds in a direction of setting a longer target distance compared to the existing target distance. When the driver intervenes by performing the accelerator pedal operation or the brake pedal operation (Yes in S42), the control unit 110 reflects the driver's pedal intervention, and learns the driver's pattern in acceleration and deceleration for determining the target distance to the preceding vehicle (S430).

The driver's tendency in acceleration and deceleration may be learned based on FIG. 2 and the related description.

In addition, the control unit 110 updates the learning parameter for determining the target distance to the preceding vehicle based on the learned driver's tendency in acceleration and deceleration (S435).

The learning parameter may include a time interval between the vehicle and the preceding vehicle, and a proportional constant of the square of a relative speed between the vehicle and the preceding vehicle.

The learning parameter may be updated based on the parametric error between the learning reference value and the target distance to the preceding vehicle, the target distance being initially set or being determined by the previous learning.

The learning parameter may be updated by the Extended Kalman Filter based on the parametric error.

In addition, the control unit 110 determines whether a coasting situation occurs in a situation in which the learning parameter is updated (S440). Furthermore, when the coasting situation occurs (Yes in S440), the control unit 110 determines the target distance to the preceding vehicle and the target acceleration based on the updated learning parameter (S445).

The coasting situation refers to a situation in which the driver releases the accelerator pedal and the preceding vehicle exists as a result of the determination in the process S405 and the process S410.

The target distance to the preceding vehicle may be determined based on the learning parameter, the minimum maintaining distance to the preceding vehicle, the speed of the vehicle, and the relative speed between the vehicle and the preceding vehicle.

The target acceleration may be determined based on the target distance to the preceding vehicle.

In addition, the control unit 110 determines a torque for following the target acceleration, i.e., a regenerative braking torque (S450), and controls the regenerative braking of the driving motor based on the determined torque while the coasting situation continues (S455).

For example, after the deceleration by the intelligent regenerative braking mode is performed, when the driver operates the acceleration pedal, it can be interpreted that the driver desires a shorter target distance compared to the current parameter, so that learning proceeds in a direction of setting a shorter target distance compared to the existing target distance. On the other hand, after the deceleration by the intelligent regenerative braking mode is performed, when the driver operates the brake pedal, it can be interpreted that the driver desires a longer target distance compared to the current parameter, so that learning proceeds in a direction of setting a longer target distance compared to the existing target distance.

The learning parameter may include a time interval between the vehicle and the preceding vehicle, and a proportional constant of the square of a relative speed between the vehicle and the preceding vehicle.

The learning parameter may be updated based on the parametric error between the learning reference value and the target distance to the preceding vehicle, the target distance being initially set or being determined by the previous learning.

The learning parameter may be updated by the Extended Kalman Filter based on the parametric error.

According to an embodiment of the present disclosure, when the target distance is determined based on the driver's accelerator pedal or brake pedal intervention, the target distance d_{des} value in Equation 1 may be fixed so that the target distance d_{des} value is not changed, and only the learning parameter according to the speed of the vehicle and the relative speed to the preceding vehicle may be changed.

In addition, when the target distance is determined, a Proportional-Derivative (PD) control may be used, and the target distance may be determined by changing only a gain value of the PD control.

In addition, according to another embodiment of the present disclosure, visualization data may be provided to the user by using the result of driver tendency learning.

For example, according to a predetermined range of the determined target distance, a level may be set in numerical or colloquial expressions, such as a level 1 to a level 4, or closer/further, and a result value of where the learned level corresponds may be provided to the user.

For example, the determined target distance may be set in the level 1 to the level 4 according to the predetermined range, and the target distance learned according to the driver's tendency may be displayed as a decimal point and may be provided to a display screen of the vehicle, a portable terminal of the driver, and so on.

In addition, the learned target distance of the driver may be compared to an average target distance of other drivers, and the comparison between the driver's tendency and the other driver's tendency may be provided. For example, when the average target distance of other drivers is in the 2.1 level and the average target distance of the current driver is in the 1.8 level, it may be determined that the current driver has a tendency to secure a safety distance less than that of other drivers.

According to embodiments of the present disclosure described above, when the driver intervenes in acceleration and deceleration during the regenerative braking operation, the driver's pedal intervention tendency may be learned and may be reflected in the driving.

In addition, conventionally, it was impossible to set a distance to a preceding vehicle in front of the vehicle in levels, or it was only possible to set a distance separated by a simplified distance such as a level 3 and a level 4, so that it was difficult to reflect the driver's tendency. However, according to embodiments of the present disclosure, the driver's tendency may be accurately reflected by learning the driver's tendency in acceleration and deceleration propensity based on the pedal intervention data of the driver during regenerative braking.

In addition, the regenerative braking learning algorithm is updated through learning, so that the number of driver's interventions in acceleration and deceleration may gradually decrease.

Therefore, during the regenerative braking function operation, the driver's intervention in acceleration and deceleration may be minimized.

According to various aspects of the present disclosure as described above, when the driver intervenes in acceleration and deceleration during the regenerative braking operation, the driver's pedal intervention tendency is capable of being learned and reflected in the driving.

In addition, as the intelligent regenerative braking in which the driver's pedal intervention tendency is reflected is provided, the driver's intervention in acceleration and deceleration during performing the regenerative braking function is capable of being minimized.

The effects that can be obtained from the present disclosure are not limited to the above-mentioned effects, and other effects not mentioned herein should be clearly understood by those having ordinary skill in the art from the description.

The present disclosure described above may be embodied as a computer-readable code on a medium in which a program is recorded. A computer-readable medium includes all types of recording devices in which data readable by a computer system is stored. Examples of the computer-readable medium include a Hard Disk Drive (HDD), a Solid-State Drive (SSD), a Silicon Disk Drive (SDD), a Read-Only Memory (ROM), a Random-Access Memory (RAM), a CD-ROM, a magnetic tape, a floppy disk, an optical data storage device, and so on. Therefore, the foregoing detailed description should not be construed as restrictive but be considered illustrative in all respects. The scope of the present disclosure should be determined by a reasonable interpretation of the appended claims, and all modifications within the equivalent scope of the present disclosure are considered included in the scope of the present disclosure.

What is claimed is:

1. A regenerative braking method comprising:
based on a release of an acceleration pedal of a vehicle during driving and a presence of a preceding vehicle, determining a pedal intervention of a driver of the vehicle;
learning, based on the pedal intervention of the driver, a tendency of the driver in acceleration and deceleration, based on whether deceleration by an intelligent regenerative braking mode is performed or not; and
controlling regenerative braking in a coasting situation based on the tendency of the driver.

2. The regenerative braking method of claim 1, wherein learning the tendency of the driver comprises:
based on that the deceleration by the intelligent regenerative braking mode is performed, determining the tendency of the driver based on whether the acceleration pedal or a brake pedal is operated or not; and
based on that the deceleration by the intelligent regenerative braking mode is not performed, determining the tendency of the driver based on whether the brake pedal is operated or not.

3. The regenerative braking method of claim 1, wherein learning of the tendency of the driver comprises:
updating a learning parameter for determining a target distance to the preceding vehicle based on the tendency of the driver.

4. The regenerative braking method of claim 3, wherein the learning parameter comprises:
a time interval between the vehicle and the preceding vehicle; and
a proportional constant of a square of a relative speed between the vehicle and the preceding vehicle.

5. The regenerative braking method of claim 3, wherein the learning parameter is updated based on a parametric error between a learning reference value and the target distance which is initially set or which is determined by a previous learning.

6. The regenerative braking method of claim 5, wherein the learning parameter is updated by an Extended Kalman Filter based on the parametric error.

7. The regenerative braking method of claim 3, wherein the target distance to the preceding vehicle is determined based on the learning parameter, a minimum maintaining distance to the preceding vehicle, a speed of the vehicle, and a relative speed between the vehicle and the preceding vehicle.

8. The regenerative braking method of claim 1, wherein controlling the regenerative braking comprises:
determining a target distance to the preceding vehicle based on the tendency of the driver; and
controlling the regenerative braking based on the target distance.

9. The regenerative braking method of claim 8, wherein controlling the regenerative braking based on the target distance comprises:
determining a target acceleration based on the target distance;
determining a regenerative torque based on the target acceleration; and
controlling a driving motor based on the regenerative torque.

10. The regenerative braking method of claim 1, wherein the preceding vehicle is in front of the vehicle.

11. A regenerative braking apparatus comprising:
a driving motor; and
a control unit configured to, based on a release of an acceleration pedal during driving and a preceding vehicle, determine a pedal intervention of a driver and learn, based on the pedal intervention of the driver, a tendency of the driver in acceleration and deceleration based on whether deceleration by an intelligent regenerative braking mode is performed or not,
wherein the control unit is further configured to control regenerative braking in a coasting situation based on the tendency of the driver.

12. The regenerative braking apparatus of claim 11, wherein the control unit is further configured to:
based on that the deceleration by the intelligent regenerative braking mode is performed, learn the tendency of the driver based on whether the acceleration pedal and a brake pedal are operated or not; and
based on that the deceleration by the intelligent regenerative braking mode is not performed, learn the tendency of the driver based on whether the brake pedal is operated or not.

13. The regenerative braking apparatus of claim 11, wherein the control unit is further configured to update a learning parameter for determining a target distance to the preceding vehicle based on the tendency of the driver.

14. The regenerative braking apparatus of claim 13, wherein the learning parameter comprises:
a time interval between the vehicle and the preceding vehicle; and
a proportional constant of a square of a relative speed between the vehicle and the preceding vehicle.

15. The regenerative braking apparatus of claim 13, wherein the learning parameter is updated based on a parametric error between a learning reference value and the target distance which is initially set or which is determined by a previous learning.

16. The regenerative braking apparatus of claim 15, wherein the learning parameter is updated by an Extended Kalman Filter based on the parametric error.

17. The regenerative braking apparatus of claim 13, wherein the target distance to the preceding vehicle is determined based on the learning parameter, a minimum maintaining distance to the preceding vehicle, a speed of the vehicle, and a relative speed between the vehicle and the preceding vehicle.

18. The regenerative braking apparatus of claim 11, wherein the control unit is further configured to:
determine a target distance to the preceding vehicle based on the tendency of the driver, and
control the driving motor based on the target distance.

19. The regenerative braking apparatus of claim 18, wherein the control unit is further configured to:
determine a target acceleration based on the target distance;
determine a regenerative torque based on the target acceleration; and
control the driving motor based on the regenerative torque.

20. The regenerative braking apparatus of claim 11, wherein the preceding vehicle is in front of the vehicle.
